(19) United States
(12) Patent Application Publication
(10) Pub. No.: US 2011/0097644 A1
(43) Pub. Date: Apr. 28, 2011

(54) FUEL CELL AND METHOD OF MANUFACTURING FUEL CELL

(75) Inventor: Masahiro Kinoshita, Aichi (JP)

(73) Assignee: Sony Corporation

(21) Appl. No.: 12/997,741

(22) PCT Filed: Jun. 12, 2009
(86) PCT No.: PCT/JP2009/060743

§ 371 Date: Dec. 13, 2010

(30) Foreign Application Priority Data
Jun. 13, 2008 (JP) 2008155140
Dec. 9, 2008 (JP) 2008313153

(51) Int. Cl. H01M 8/10

(52) U.S. Cl. 429/483; 429/535

(57) ABSTRACT

A small fuel cell capable of realizing stable output and a method of manufacturing the same are provided. A fuel cell 1 includes a Membrane Electrolyte Assembly (MEA) 13 in which a fuel electrode 16 and an oxygen electrode 14 are oppositely arranged with an electrolyte membrane 15 in between; a first pressing plate 10 and a second pressing plate 11 arranged oppositely to the MEA 13 and a peripheral region 13D; a through hole 12 provided to penetrate from the first pressing plate 10 to the second pressing plate 11 through the peripheral region 13D; and a resin layer 20 embedded in the through hole 12. By the resin layer 20 formed in the through hole 12, the MEA 13 is held under pressure between the first pressing plate 10 and the second pressing plate 11. Compared to a case using a metal screw, a fastening space is decreased, and a space for securing insulation is not necessitated. Due to the elasticity of the resin layer 20, pressurization state is easily retained.

### TECHNICAL FIELD

The present invention relates to a fuel cell including a Membrane Electrolyte Assembly (MEA) in which a pair of electrodes are oppositely arranged with an electrolyte membrane in between and a method of manufacturing the same.

### BACKGROUND ART

In recent years, a fuel cell has attracted attention as a power source of electronic devices. The fuel cell has a Membrane Electrolyte Assembly (MEA) in which an electrolyte membrane is arranged between an anode (fuel electrode) and a cathode (oxygen electrode). A fuel is supplied to the fuel electrode, and air or oxygen is supplied to the oxygen electrode, respectively. As a result, redox reaction is initiated in the fuel electrode and the oxygen electrode, and part of chemical energy of the fuel is converted to electric energy, which is extracted as electric power.

In such a fuel cell, to perform effective power generation, it is desirable to improve contact characteristics between respective layers in the MEA. Thus, a technique that the MEA is sandwiched between other plate materials or the like and is held under pressure by fastening with the use of a metal screw has been proposed (for example, Patent Literatures 1 and 2). In Patent Literature 1, a laminated body in which a plurality of MEAs are layered in the in-plane vertical direction is sandwiched between a pair of fastening plates and is screwed, and the laminated body is held under pressure by using axial advancing force of the screw. In Patent Literature 2, an assembly in which a plurality of MEAs are arranged in the in-plane direction is fastened by a screw in the outer circumferential section.

### CITATION LIST

### Patent Literature

PTL1: Japanese Unexamined Patent Application Publication No. 2006-120589
PTL2: Japanese Unexamined Patent Application Publication No. 2004-327105

### SUMMARY OF INVENTION

However, in the techniques of Patent Literatures 1 and 2, since the metal screw is used, a space for screwing and a space for securing insulation to the MEA are necessitated. These spaces are hardly secured as the fuel cell is progressively miniaturized. Further, after fastening, fastening force is weakened by swelling of the MEA due to power generation, which results in difficulty to retain pressurized state in fastening over time. Further, in the assembly in which the plurality of MEAs are arranged along the in-plane direction as in Patent Literature 2, it is difficult to secure the screwing space for each MEA, and pressurization in the in-plane direction is easily nonuniform. In the result, there has been a disadvantage that the output becomes unstable.

In view of the foregoing disadvantages, it is an object of the present invention to provide a small fuel cell capable of realizing stable output and a method of manufacturing the same.

A fuel cell of the present invention includes an MEA in which a fuel electrode and an oxygen electrode are oppositely arranged with an electrolyte membrane in between; a pair of pressing plates that are respectively provided on the fuel electrode side and the oxygen electrode side of the MEA, and are arranged oppositely to the MEA and a peripheral region thereof; a through hole that penetrates from one of the pair of pressing plates to the other of the pair of pressing plates through the peripheral region of the MEA; and a resin layer embedded in the through hole.

A method of manufacturing a fuel cell of the present invention includes the steps of: forming an MEA in which a fuel electrode and an oxygen electrode are oppositely arranged with an electrolyte membrane in between; and sandwiching the MEA and a peripheral region thereof between a pair of pressing plates each having an aperture opposite to each other in the peripheral region, and injecting a molten thermoplastic resin material under a given pressure into the aperture of one of the pair of pressing plates.

In the fuel cell of the present invention, the pair of pressing plates are provided oppositely to the MEA and the peripheral region of the MEA, and the resin layer is embedded in the through hole that penetrates the respective pressing plates and the peripheral region. By the resin layer, the MEA is held under pressure. Thereby, compared to fastening with the use of a metal screw, a fastening space is decreased, and a space for securing insulation to the MEA is not necessitated. Further, due to elasticity of the resin, given pressurization state is easily retained.

In the method of manufacturing a fuel cell of the present invention, the MEA and the peripheral region thereof are sandwiched between the pair of pressing plates each having an aperture opposite to each other in the peripheral region, and the molten thermoplastic resin material is injected into the aperture of one of the pair of pressing plates under a given pressure. Thereby, the molten resin material reaches the aperture of the other pressing plate from the aperture of one pressing plate through the peripheral region of the MEA. After that, as the resin material is continuously injected, the resin material is gradually cured from the other pressing plate side to the vicinity of the aperture of one pressing plate in the course of injection. Thereby, the resin layer is embedded in the through hole penetrating the pair of pressing plates in the peripheral region of the MEA.

According to the fuel cell and the method of manufacturing a fuel cell of the present invention, the pair of pressing plates are provided oppositely to the MEA and the peripheral region of the MEA, and the resin layer is embedded in the through hole that penetrates the respective pressing plates and the peripheral region sandwiched between the pressing plates. Thus, a small fuel cell capable of realizing stable output is able to be realized.

### BRIEF DESCRIPTION OF DRAWINGS

FIG. 1 is a cross sectional view illustrating a structure of a fuel cell according to a first embodiment of the present invention.

FIG. 2 is a plan view of the first pressing plate illustrated in FIG. 1.

FIG. 3 is cross sectional view illustrating a method of manufacturing the fuel cell illustrated in FIG. 1 in order of steps.

FIG. 4 is a cross sectional view illustrating a step following FIG. 3.

FIG. 5 is a cross sectional view illustrating a step following FIG. 4.

FIG. 6 is a cross sectional view illustrating a step following FIG. 5.

FIG. 7 is a schematic view illustrating a structure of a jig used in the step of FIG. 6.

FIG. 8 is a cross sectional view illustrating a step following FIG. 6.

FIG. 9 is a cross sectional view illustrating a step following FIG. 7.

FIG. 10 is a plan view illustrating a structure seen from the first pressing plate side of a fuel cell according to a first modified example.

FIG. 11 is a plan view illustrating a structure seen from the first pressing plate side of a fuel cell according to a second embodiment of the present invention.

FIG. 12 is a cross sectional view illustrating a schematic structure of the fuel cell illustrated in FIG. 11.

FIG. 13 is cross sectional view illustrating a method of manufacturing the fuel cell illustrated in FIG. 11 in order of steps.

FIG. 14 is a cross sectional view illustrating a step following FIG. 13.

FIG. 15 is a cross sectional view illustrating a step following FIG. 14.

FIG. 16 is a cross sectional view illustrating a step following FIG. 15.

FIG. 17 is a plan view illustrating a structure seen from the first pressing plate side of a fuel cell according to a second modified example.

FIG. 18 is a plan view illustrating a structure seen from the first pressing plate side of a fuel cell according to a third modified example.

FIG. 19 is a plan view illustrating a structure seen from the first pressing plate side of a fuel cell according to a fourth modified example.

### DESCRIPTION OF EMBODIMENT

Embodiments of the present invention will be hereinafter described in detail. In addition, the description will be given in the following order. In a second embodiment, a second modified example, and first to fourth modified examples 1 to 4, the same referential symbols are affixed to elements similar to those of a first embodiment, and the description thereof will be omitted as appropriate.

(1) First embodiment: example of an assembly in which six MEAs are connected in the shape of U
(2) First modified example: example that a cross sectional area of an in-plane through hole in the assembly of (1) is changed according to each region
(3) Second embodiment: example that a terminal section is drawn out in the direction not in parallel with an extending direction of an electrode section from the vicinity of the center of the electrode section in an assembly in which nine MEAs are linearly connected

(3-1) Second modified example: example that a terminal section is drawn out in the direction in parallel with an extending direction of an electrode section from one end of the electrode section in the assembly of (3)

(4) Third modified example: example that a terminal section is drawn out in the direction not in parallel with an extending direction of an electrode section from a space between adjacent through holes in the assembly of (3)
(5) Fourth modified example: example that a terminal section is drawn out in the direction in parallel with an extending direction of an electrode section from both ends of the electrode section in the assembly of (3)

### First Embodiment

### 1. Structure of a Fuel Cell 1

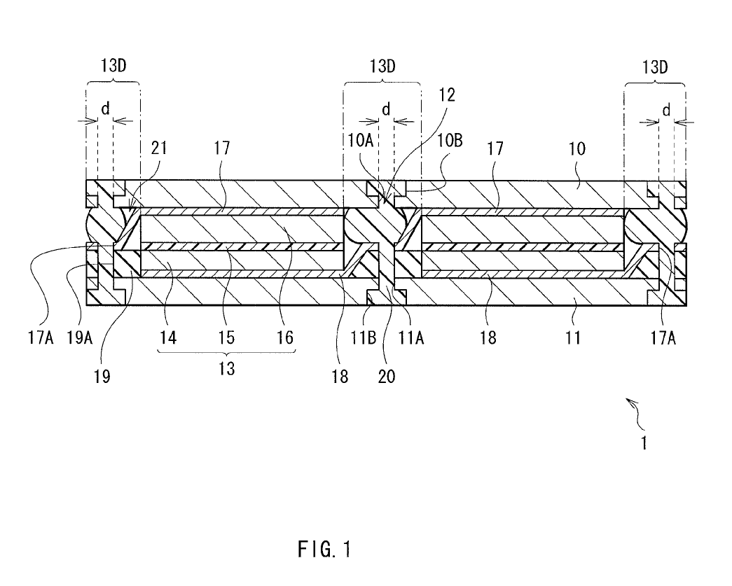

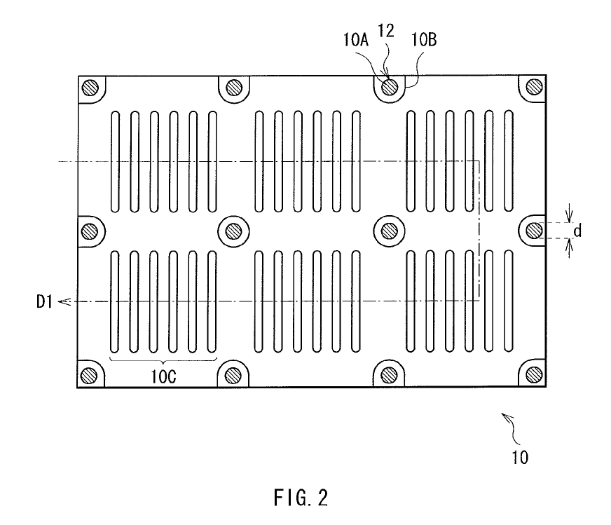

FIG. 1 illustrates a cross sectional structure of the fuel cell 1 according to the first embodiment of the present invention. FIG. 2 is a view seen from a first pressing plate side of the fuel cell of FIG. 1. The fuel cell 1 is, for example, a Direct Methanol Fuel Cell (DMFC) used for, for example, a mobile device such as a mobile phone and a PDA (Personal Digital Assistant) or a notebook PC (Personal Computer). In the fuel cell 1, an assembly in which a plurality of MEAs 13 are linked in the in-plane direction is formed.

In the MEA 13, a fuel electrode 16 and an oxygen electrode 14 are oppositely arranged with an electrolyte membrane 15 in between. The plurality of MEAs 13 are sandwiched between separators (connection members) 17 and 18 from the fuel electrode 16 side and the oxygen electrode 14 side, respectively, and are electrically connected in series (for example, along connection direction D1 of FIG. 2). In this embodiment, six MEAs (assembly) are linked in the shape of U in the in-plane direction.

The electrolyte membrane 15 is made of a proton conductive material having, for example, a sulfonic acid group (—SO₃H). Examples of the proton conductive material include a polyperfluoroalkyl sulfonic acid proton conductive material (for example, “Nafion (registered trademark) produced by DuPont), a hydrocarbon proton conductive material such as polyimide sulfonic acid, and a fullerene proton conductive material.

The fuel electrode 16 and the oxygen electrode 14 have a structure in which, for example, a catalyst layer containing a catalyst such as platinum (Pt) and ruthenium (Ru) is formed on a current collector made of, for example, carbon paper or the like. The catalyst layer is composed of, for example, a layer in which a support substance such as carbon black supporting the catalyst is dispersed in a polyperfluoroalkyl sulfonic acid proton conductive material or the like.

On the fuel electrode 16 side and the oxygen electrode 14 side of the MEA 13, a first pressing plate 10 and a second pressing plate 11 are respectively arranged with the separators 17 and 18 in between. In a selective position of a peripheral region 13D of the MEA 13, a through hole 12 that penetrates from the first pressing plate 10 side to the second pressing plate 11 side is provided.

The first pressing plate 10 and the second pressing plate 11 are arranged oppositely to a region where the MEA 13 is formed and the peripheral region 13D thereof. Physical intensity of the linked MEAs 13 is maintained by the first pressing plate 10 and the second pressing plate 11, and contact characteristics between the respective layers of the MEA 13/the MEA 13 and the separators 17 and 18 is secured by the first pressing plate 10 and the second pressing plate 11. Further, in the peripheral region 13D, a seal section 19 is formed along the outer circumference of the MEA 13 between the second pressing plate 11 and the separators 17, 18.

The first pressing plate 10 and the second pressing plate 11 are composed of, for example, aluminum (Al) provided with alumite treatment, super engineering plastic or engineering plastic such as polyphenylene sulfide and polyether ketone, ceramics, or a metal material such as stainless steel provided with insulation treatment. Further, as illustrated in FIG. 2, the first pressing plate 10 has an aperture 10C for supplying a fuel to the fuel electrode 16 side. The fuel is supplied from a fuel tank or the like (not illustrated). Further, similarly, the second pressing plate 11 is provided with an aperture for supplying oxygen (air) to the oxygen electrode 14 side. For example, air is able to be taken in by communicating with outside. In addition, though FIG. 2 illustrates a planar structure of the first pressing plate 10, a planar structure of the second pressing plate 11 is similar to the planar structure of the first pressing plate 10.

The through hole 12 is provided, for example, at even intervals in the in-plane direction of the fuel cell 1, and the cross sectional shape thereof is, for example, a circle having a diameter d. That is, in the peripheral region 13D, the first pressing plate 10, the separator 17 (separator 18), the seal section 19, and the second presser 11 respectively have each circular aperture (apertures 10A, 17A, 19A, and 11A) having the diameter d corresponding to the through hole 12. It is desirable that the apertures 10A, 17A, 19A, and 11A are arranged opposed to each other and have the same shape, since thereby a resin layer 20 described later is easily formed. Meanwhile, in the peripheral region 13D, a space between the first pressing plate 10 and the separator 17 (separator 18) is a region 21 (air gap) that forms the through hole 12 together with the foregoing apertures 10A, 17A, 19A, and 11A. The resin layer 20 is embedded in the through hole 12.

Further, on the surface side (opposite side of the MEA 13) of a region corresponding to the through hole 12 of the first pressing plate 10 and the second pressing plate 11, concave sections 10B and 11B having a bottom face with a larger area than that of the apertures 10A and 11A are respectively provided.

The resin layer 20 is made of a resin material having thermal plasticity such as polypropylene (PP), polyethylene (PE), polyvinyl chloride (PVC), an ABS resin (acrylonitrile-butadiene-styrene copolymer), nylon, polyacetal (POM), a fluorine resin, polymethyl pentene (PMP), polyacrylonitrile (PAN), an acrylate resin, silicon rubber, chloroprene rubber, and fluorine rubber. As a component material of the resin layer 20, a material having a melting point from 210 degrees to 230 degrees both inclusive is desirable for the following reason. That is, such a material is not necessarily provided with a cooling step differently from injection molding method in which a molten resin material is poured into a metal mold and subsequently the molten resin material is cooled and solidified in forming the resin layer 20. Further, the component material of the resin layer 20 desirably has resistance to methyl alcohol or the like. From viewpoint of the foregoing, as the component material of the resin layer 20, polypropylene is suitable.

The separators 17 and 18 have a function to electrically connect adjacent MEAs in series. The separators 17 and 18 are respectively arranged being contacted with the fuel electrode 16 and the oxygen electrode 14 of the MEA 13, and form a flow path through which a fuel or air is supplied. Such separators 17 and 18 are composed of, for example, copper (Cu), nickel (Ni), titanium (Ti), stainless steel (SUS) or the like. Further, such separators 17 and 18 have an aperture (not illustrated) for supplying a fuel or air, and are composed of, for example, mesh such as an expanded metal, a punching metal or the like. Further, the separators 17 and 18 are bent in the peripheral region 13D of the MEA 13. The seal section 19 is provided between the bent section and the second pressing plate 11.

The seal section 19 is composed of, for example, polypropylene, acid modified polypropylene, polyvinyl alcohol, polyethylene terephthalate (PET) or the like. The seal section 19 is intended to seal the peripheral region 13D of the respective MEAs 13 to inhibit entering of air from the side face.

The fuel cell 1 is able to be manufactured, for example, as follows.

### 2. Method of Manufacturing the Fuel Cell 1

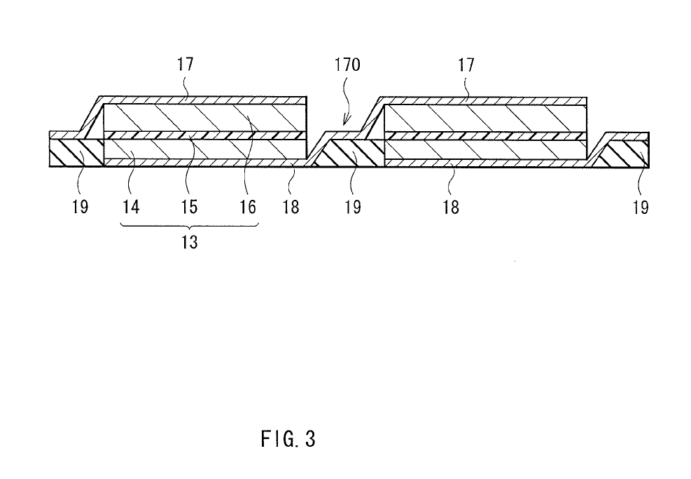

FIG. 3 to FIG. 9 illustrate a method of manufacturing the fuel cell 1 in order of steps. First, as illustrated in FIG. 3, an assembly in which the plurality of MEAs 13 are linked is formed. For example, the electrolyte membrane 15 made of the foregoing material is sandwiched between the fuel electrode 16 and the oxygen electrode 14 made of the foregoing material and thermally compression-molded to form the MEAs 13. Subsequently, the separators 17 and 18 made of the foregoing material are prepared. One end thereof is bent, and the seal section 19 made of the foregoing material is formed at the bent end. Subsequently, the separator 17 is arranged on the fuel electrode 16 side and the separator 18 is arranged on the oxygen electrode 14 side, respectively so that the separators 17 and 18 are opposed to each other, and the resultant is thermally compression-molded. In this way, the plurality of MEAs 13 sandwiched between the separators 17 and 18 are formed, and the plurality of MEAs 13 are linked in the in-plane direction. At this time, for example, in adjacent MEAs 13, an end of the separator 17 on one MEA 13 is linked to an end of the separator 18 of the other MEA 13 in a link section 170.

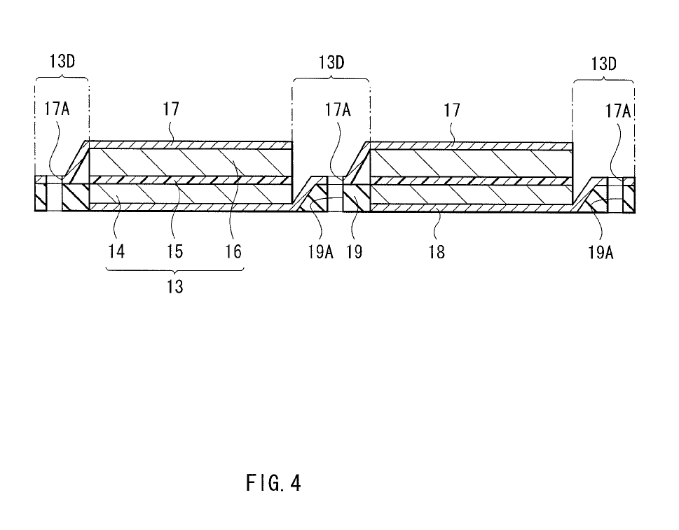

Subsequently, as illustrated in FIG. 4, in a selective position in the peripheral region 13D of the respective MEAs 13, the apertures 17A and 19A are respectively formed in the separators 17, 18, the link section 170 thereof, and the seal section 19 by, for example, sheet pressing, punching or the like.

Meanwhile, the concave sections 10B and 11B are formed in the first pressing plate 10 and the second pressing plate 11 by, for example, pressing, half etching, diffusion joining or the like. After that, at the bottom face of the concave sections 10B and 11B, the apertures 10A and 11A are formed by, for example, pressing, milling or the like.

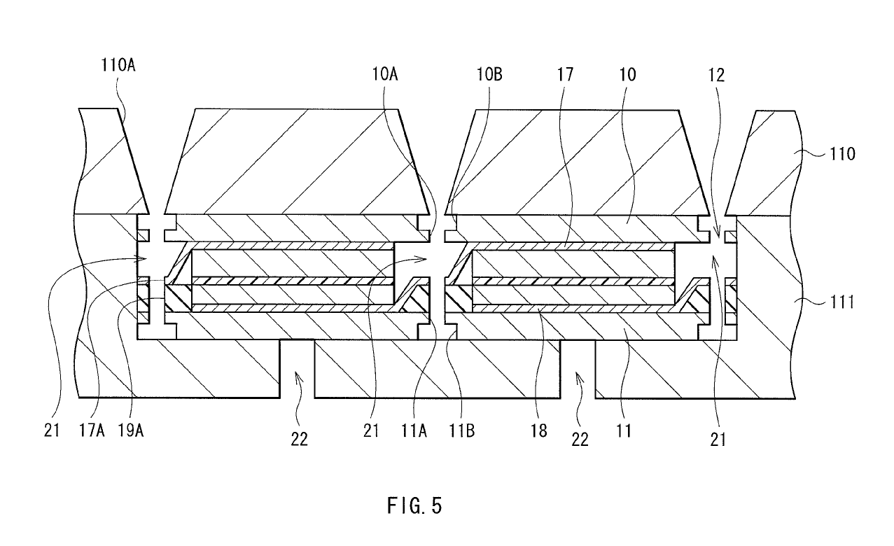

Next, as illustrated in FIG. 5, the first presser 10 is laid on the separator 17 side (fuel electrode 16 side) of the linked MEAs 13 and the second presser 11 is laid on the separator 18 side (oxygen electrode 14 side) so that the apertures 10A, 11A, 17A, and 19A are opposed to each other, and the resultant is thermally compression-molded. Thereby, the linked MEAs 13 are sandwiched between the first pressing plate 10 and the second pressing plate 11, and the through hole 12 is formed. After that, an upper mold 110 is contacted with the first pressing plate 10 side, and a lower mold 111 is contacted with the second pressing plate 11 side. In the upper mole 110, an injection hole 110A is provided in a position opposed to the through hole 12. In the lower mold 111, an air hole 22 is provided.

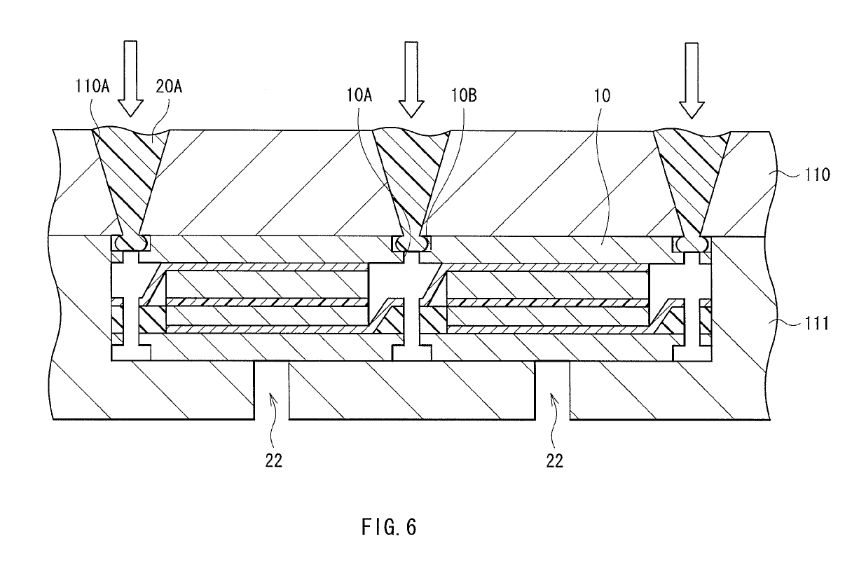

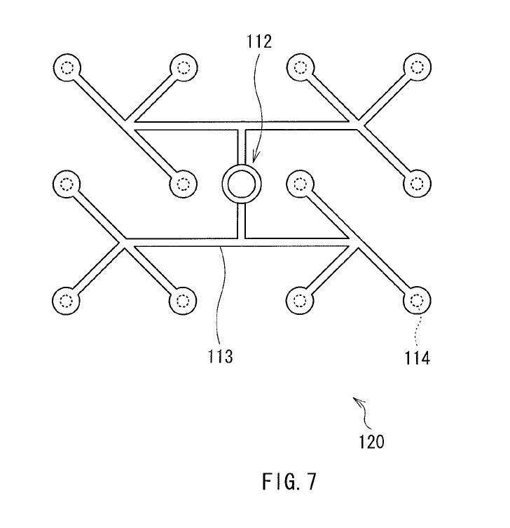

Subsequently, the resin layer 20 is formed by so-called melt flow injection method in which the foregoing resin material in a molten state (resin 20A) is flown into the through hole 12. That is, as illustrated in FIG. 6, for example, the resin 20A is flown from the injection hole 110A of the upper mold 110 under pressure of, for example, from 0.25 to 0.35 MPa both inclusive. At this time, the resin 20A is concurrently injected to the plurality of injection holes 110A by using a jig 120 as illustrated in FIG. 7, for example. The jig 120 is provided with a sprue 112 as an injection port of the resin 20A, a plurality of runners 113 as a flow path of the resin 20A injected form the sprue 112, and a gate 114 provided at the tip of the respective runners 113. In the plurality of runners 113, each length of a route from the sprue 112 to the gate 114 provided at the end of the respective runners 113 is equal to each other. When used, the gate 114 of the jig 120 is arranged oppositely to the injection hole 110A of the upper mold 110, and the resin 20A is injected from the sprue 112. Thereby, the injected resin 20A is dispersed into the respective runners 113 and reaches the injection hole 110A through the respective gates 114, while the resin 20A is uniformly and concurrently injected to the respective injection holes 110A.

When the resin 20A is concurrently injected to the respective injection holes 110A of the upper mold 110 as described above, the resin 20A is firstly flown along the shape of the concave section 10B formed on the surface of the first pressing plate 10. Further, by injecting the resin 20A from the fuel electrode 16 side, sealing characteristics on the fuel electrode 16 side is able to be improved.

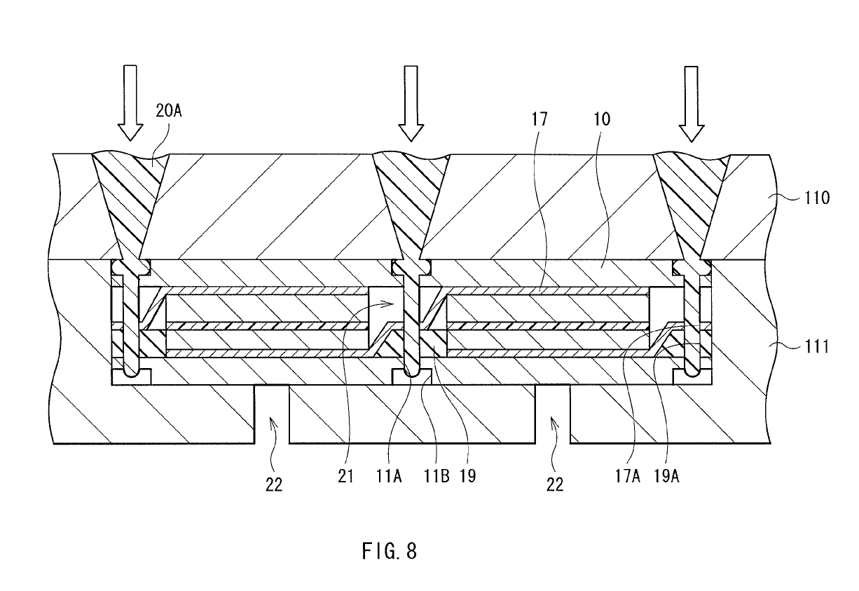

Subsequently, as illustrated in FIG. 8, as the resin 20A is continuously injected, the resin 20A diffused in the concave section 10B passes through the aperture 10A of the first pressing plate 10, the region 21, the aperture 17A of the separators 17 and 18, the aperture 19A of the seal section 19, and the aperture 11A of the second pressing plate 11 in this order, and reaches the concave section 11B of the second pressing plate 11. At this time, the resin 20A flowing through the through hole 12 is sealed by the upper mold 110 and the lower mold 111, and thus the resin 20A is not flown outside. Further, since the internal pressure is increased by injection pressure of the resin 20A, internal airtightness is retained. Further, due to the air hole 22 provided in the lower mold 111, internal pressure is adjusted to avoid internal destruction of the MEA 13, and reaction to each electrode by ejection of generated gas is inhibited. At this time, as the position of the resin 20A is closer to the injection hole 11A, temperature is higher. As the position of the resin 20A is farther from the injection hole 11A, temperature is gradually lower. Thus, viscosity of the resin 20A in the vicinity of the surface of the injection hole 110A is larger, and viscosity of the resin 20A in the vicinity of the second pressing plate 11 is smaller.

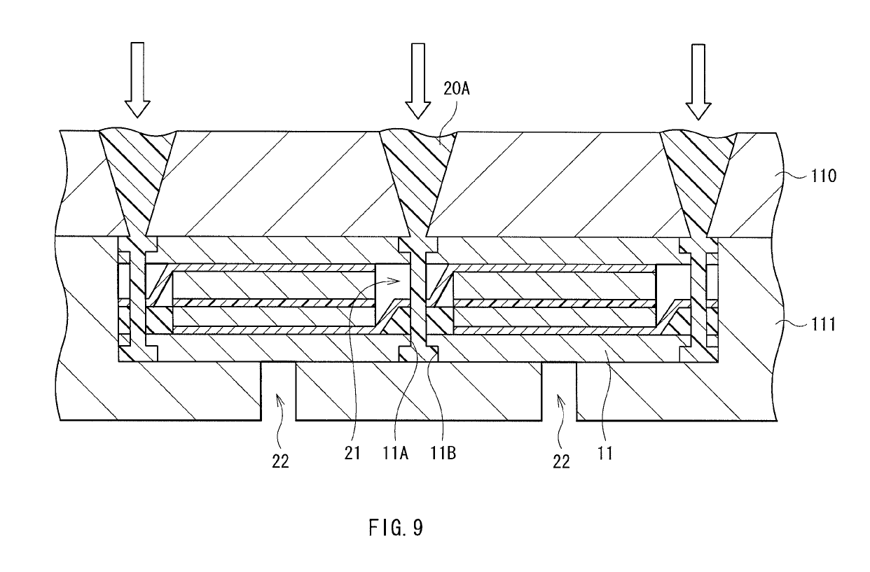

Next, as illustrated in FIG. 9, as the resin 20A is further injected, the resin 20A is flown and diffused in the whole concave section 11B of the second pressing plate 11. The resin 20A is cured sequentially from the concave section 11B to the concave section 10B of the first pressing plate 11. In this step, the air gap part of the region 21 is also filled with the resin 20A which is to be cured, and the resin layer 20 is embedded in the through hole 12. Since the resin 20A is diffused into the concave sections 10B and 11B and cured as described above, the MEA 13 is held under pressure (fastened) by the first pressing plate 10 and the second pressing plate 11. At this time, since the first pressing plate 10 and the second pressing plate 11 are respectively provided with the concave sections 10B and 11B, even if variation exists in the injection amount of the resin 20A for the respective through holes 12, such variation is absorbed, and uniform pressurization is easily made. Finally, after a given amount of the resin 20A is injected, the resin injection route is hermetically sealed while pressurization state is held. Accordingly, the fuel cell 1 illustrated in FIG. 1 is completed.

Next, operation and effect of this embodiment will be described.

### 3. Operation of the Fuel Cell 1

In the foregoing fuel cell 1, while a fuel is supplied through the first pressing plate 10 and the separator 17 to the fuel electrode 16, oxygen is supplied through the second pressing plate 11 and the separator 18 to the oxygen electrode 14. In the result, redox reaction is initiated, and chemical energy of the fuel is converted to electric energy, which is extracted as electric power.

In this case, the through hole 12 is provided in the peripheral region 13D of the first pressing plate 10 and the second pressing plate 11 that sandwich the linked MEAs 13, and the resin layer 20 is embedded in the through hole 12. Thereby, the MEA 13 is fastened, and is retained under pressure. By using the resin layer 20 as described above, the fastening space is smaller than that of fastening by a metal screw, and the space for securing insulation to the MEA 13 is not necessitated. Thus, in particular, in the case where a plurality of MEAs 13 are linked in the in-plane direction, the fastening space is able to be secured in each surrounding area of the plurality of MEAs 13, and the whole in-plane of the fuel cell 1 is able to be uniformly pressurized.

Further, in the case where a metal screw is used, fastening force is weakened by swelling of the MEA due to power generation, and it is difficult to retain pressurization state in fastening over time. However, in this embodiment, due to elasticity of the resin 20, given pressurization state is easily retained after fastening. Further, fuel leakage is inhibited by the resin layer 20.

Further, in the foregoing method of manufacturing the fuel cell 1, the MEA 13 and the peripheral region 13D are sandwiched between the first pressing plate 10 and the second pressing plate 11 respectively having the apertures 10A and 11A, and the molten resin 20A is injected under a given pressure into the aperture 10A of the first pressing plate 10. Thereby, the molten resin 20A is gradually cured from the second pressing plate 11 side in the through hole 12. Thereby, the resin layer 20 is embedded in the through hole 12. As described above, by flowing the molten resin 20A into the through hole 12 under a given pressure and solidifying the molten resin 20A by natural cooling, the resin layer 20 is formed only in a selective position of the peripheral region 13D of the MEA 13.

As described above, in this embodiment, the first pressing plate 10 and the second pressing plate 11 are provided oppositely to the MEA 13 and the peripheral region 13D, and the resin layer 20 is embedded in the through hole 12 formed in the peripheral region 13D. Thus, the small fuel cell 1 capable of realizing stable output is able to be realized.

### Modified Example 1

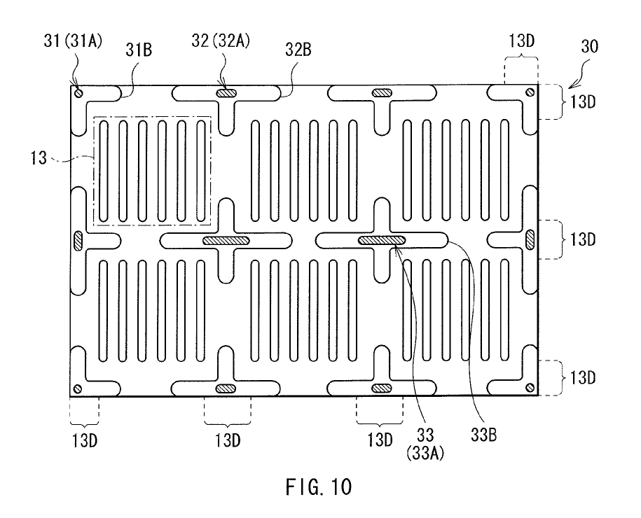

FIG. 10 is a plan view seen from the first pressing plate side of a fuel cell according to a modified example of the foregoing embodiment. The structure of the fuel cell in this modified example is similar to that of the fuel cell 1 of the foregoing embodiment, except for the structure of a through hole and the structure of the shape of a concave section of a first pressing plate and a second pressing plate. In this modified example, the second pressing plate (not illustrated) has a structure similar to that of a first pressing plate 30.

The fuel cell of this modified example has through holes 31, 32, and 33 in the peripheral region 13D of the MEA 13. The through holes 31, 32, and 33 respectively have each different cross sectional area according to each in-plane region. The cross sectional area in the in-plane internal region is larger than the cross sectional area in the end region (outer circumferential section of the fuel cell). That is, planar shape of the first pressing plate 30 is a rectangle. The cross sectional area is increased in order of the through hole 31 provided in four corners of the rectangle, the through hole 32 provided in a region opposed to a side of the rectangle, and the through hole 33 provided in the central region of the rectangle. In the first pressing plate 30, apertures 31A, 32A, and 33A having a cross sectional area equal to those of the foregoing through holes 31, 32, and 33 are formed, and concavity sections 31A, 32B, and 33B having a bottom area larger than the cross sectional areas of the through holes 31, 32, and 33 are provided.

As described above, by forming the cross sectional areas of the through holes 31, 32, and 33 different from each other according to each in-plane region, fastening corresponding to reactive force in the plane of the fuel cell is enabled. In general, in an assembly in which MEAs are linked in the in-plane direction, reactive force is strongest in the vicinity of the center of the entire assembly, and reactive force is weaker in the end region. Thus, strictly speaking, it is difficult to perform uniform holding under pressure between the center and the end. In this modified example, by providing the cross sectional areas of the through holes 31, 32, and 33 different from each other according to each region, holding force according to the foregoing reactive force is able to be given. Thus, more uniform holding under pressure is enabled.

Further, according to the cross sectional area size of each through hole, tensile strength is able to be arbitrarily set, and thus torque management after fastening or the like is not necessitated. Further, due to uniform pressurization, physical strength is easily secured without depending on the thickness of the first pressing plate 30 and the second pressing plate, resulting in realizing a thin fuel cell.

In addition, the shape of the cross sectional area of the foregoing through holes is not particularly limited. Since the holding force is determined by the cross sectional area size, shape designing of through holes has degree of freedom. Further, in the first modified example, the description has been given of the case that the cross sectional area size of the through holes is changed according to each region for fastening according to the reactive force. However, the structure is not limited thereto, but, for example, it is possible that the number of through holes is changed according to each region, and the through holes are arranged in the internal region more densely than in the end region. In this structure, resin fastening according to the reactive force is enabled as well, and effect equal to that of the foregoing first modified example is able to be obtained.

### Second Embodiment

### 1. Structure of a Fuel Cell 2

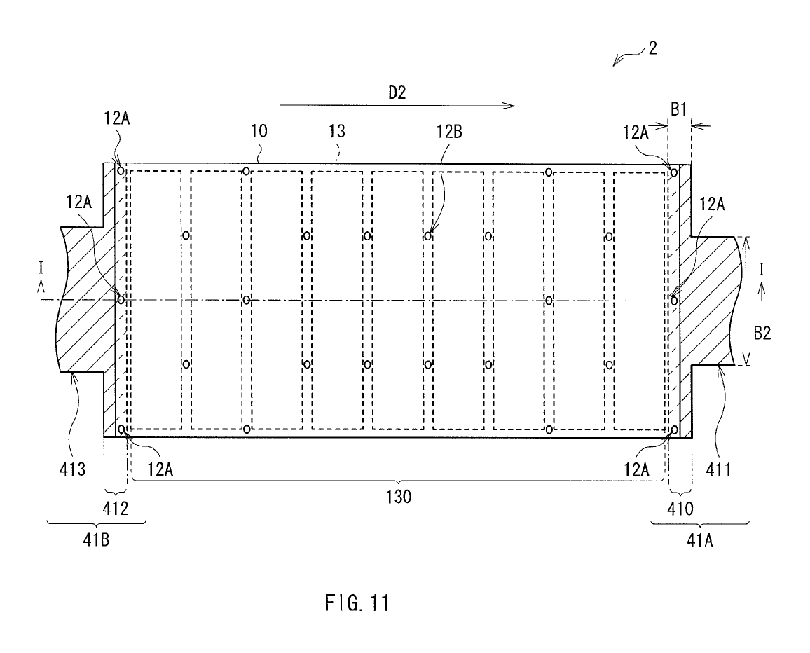

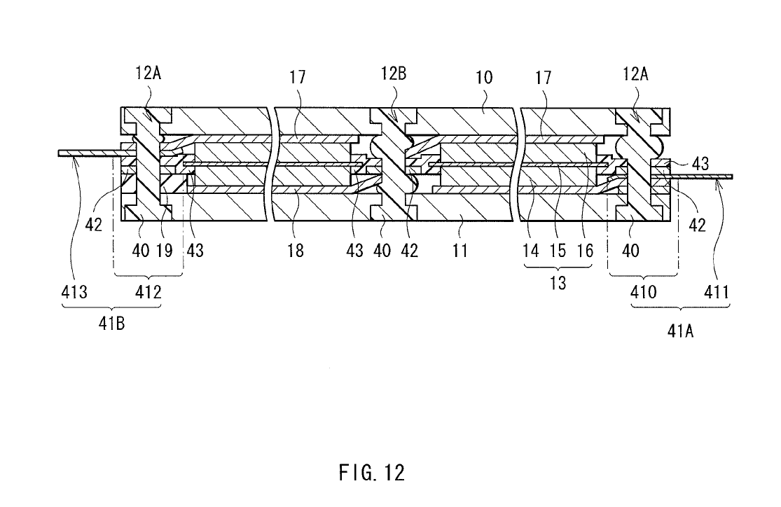

FIG. 11 is a view seen from the side of the first pressing plate 1 of the fuel cell 2 according to the second embodiment of the present invention. FIG. 12 illustrates a cross sectional structure taken along line I-I of the fuel cell 2 illustrated in FIG. 11. The fuel cell 2 is a Direct Methanol Fuel Cell as the fuel cell 1 of the foregoing first embodiment. The fuel cell 2 has an assembly (assembly 130) in which the plurality of MEAs 13 are electrically connected in series (hereinafter simply referred to “connected in series”). However, in this embodiment, in the assembly 130, nine rectangular MEAs 13 are linearly linked. To fasten the assembly 130 by being sandwiched between the first pressing plate 10 and the second pressing plate 11, the plurality of through holes 12A and 12B are provided in a pattern different from that of the foregoing first embodiment. In this embodiment, in such a structure, a description will be given in detail particularly of electrode terminals 41A and 41B for external connection.

Structure of the Electrode Terminals

The planar shape of the assembly 130 is, for example a rectangle. The electrode terminal 41A on + (plus) side is attached to one end in connection direction D2 of the assembly 130, and the electrode terminal 41B on − (minus) side is attached to the other end thereof. The electrode terminal 41A is connected to the assembly 130 with the separator 18 in between, and the electrode terminal 41B is connected to the assembly 130 with the separator 17 in between, respectively. In the following description, “end or end side of the assembly 130” means the end or the end side in the connection direction D2 of the assembly 130.

Such an assembly 130 is provided with the plurality of through holes 12A and 12B. The resin layer 40 is embedded in the through holes 12A and 12B, and thereby resin fastening is made. Six through holes 12A in total are provided in both ends of the assembly 130, specifically, in four corners of the assembly 130 and in the vicinity of the center of the end sides thereof. Resin fastening is desirably made in both ends of the assembly 130 as above. Thereby, the assembly 130 is uniformly held under pressure, and physical strength is easily secured. In a region between adjacent MEAs 13 out of regions other than both ends of the assembly 130, a plurality of (in this case, 18) through holes 12B are provided at equal intervals. The resin layer 40 is made of a material similar to that of the resin layer 20 of the foregoing first embodiment.

The electrode terminal 41A is composed of an electrode section 410 extending along the end side of the assembly 130 and a terminal section 411 drawn out from a partial region of the electrode section 410 in the direction not in parallel with the extending direction of the electrode section 410. In this embodiment, the terminal section 411 is drawn out from the vicinity of the center of the electrode section 410 in the direction orthogonal to the extending direction of the electrode section 410. As the electrode terminal 41A is, the electrode terminal 41B is composed of an electrode section 412 extending along the end side of the assembly 130 and a terminal section 413 drawn out from part of the electrode section 412 to outside.

Examples of a material composing the electrode terminals 41A and 41B include titanium (Ti), molybdenum (Mo), tungsten (W), gold (Au), copper (Cu), brass, and copper plated with gold. Width B1 of the electrode sections 410 and 412 is, for example, about from 1 mm to 3 mm both inclusive. Width B2 of the electrode sections 411 and 413 is wider than the width B1 of the electrode sections 410 and 412, and is preferably about from 3 mm to 10 mm both inclusive.

As described above, both the through hole 12A for fastening and the electrode sections 410 and 412 of the electrode terminals 41A and 41B are provided in both ends of the assembly 130. That is, the through hole 12A is provided to penetrate the electrode sections 410 and 412 in both ends of the assembly 130.

Specifically, as illustrated in FIG. 12, in one end (+ side) of the assembly 130, the seal section 19, the separator 18, the electrode terminal 41A, a titanium sheet 42, and a seal section 43 are layered between the first pressing plate 10 and the second pressing plate 11. The through hole 12A is provided to penetrate all the layers from the first pressing plate 10 to the second pressing plate 11. In the other end (− side) of the assembly 130, the seal section 19, the titanium sheet 42, the seal section 43, the electrode terminal 41B, and the separator 17 are layered between the first pressing plate 10 and the second pressing plate 11. The through hole 12A is provided to penetrate all the layers. In regions other than both ends of the assembly 130, the separator 18, the titanium sheet 42, the seal section 43, and the separator 17 are layered between the first pressing plate 10 and the second pressing plate 11. The through hole 12B is provided to penetrate all the layers.

### 2. Method of Manufacturing the Fuel Cell 2

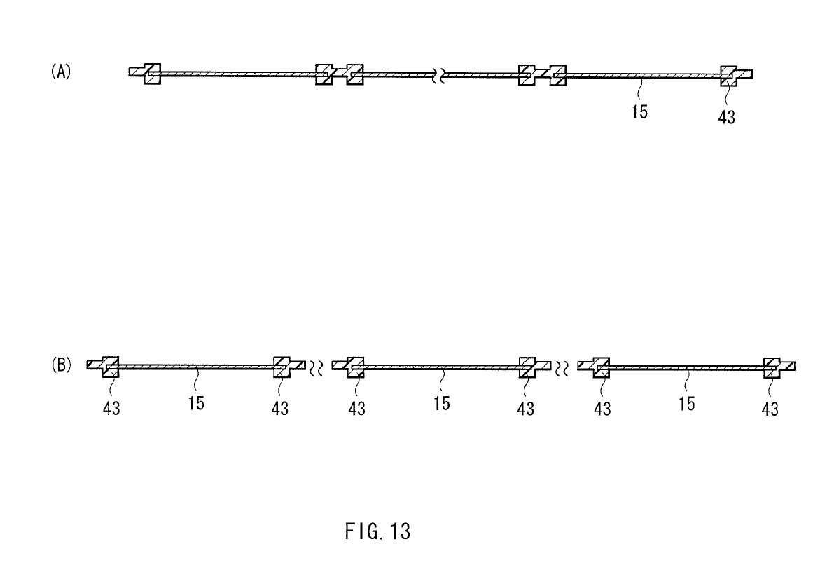

The fuel cell 2 attached with such electrode terminals 41A and 41B is able to be manufactured, for example, as follows. First, the electrolyte membrane 15 and the seal section 43 are cut in a given shape and are bonded to each other, and the resultant is subsequently heated. Thereby, as illustrated in FIG. 13(A), an electrolyte sheet in which the electrolyte membrane 15 and the seal section 43 are linked is formed. Subsequently, as illustrated in FIG. 13(B), the formed electrolyte sheet is cut, and thereby the plurality of electrolyte membranes 15 around which the seal section 43 is provided are formed.

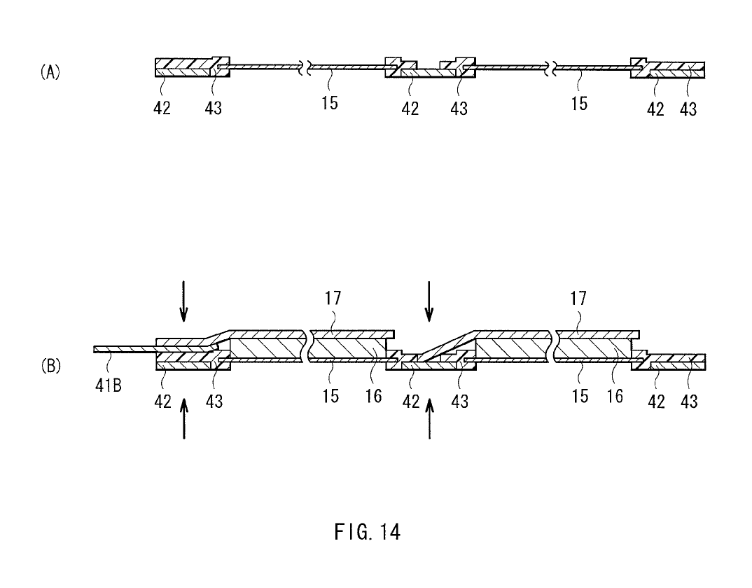

Next, as illustrated in FIG. 14(A), the electrolyte membrane 15 around which the seal section 43 is formed is aligned with the titanium sheet 42 having an aperture in a region corresponding to the electrolyte membrane 15, and the resultant is heat-sealed. Thereby, nine electrolyte membranes 15 are linearly linked on the titanium sheet 42.

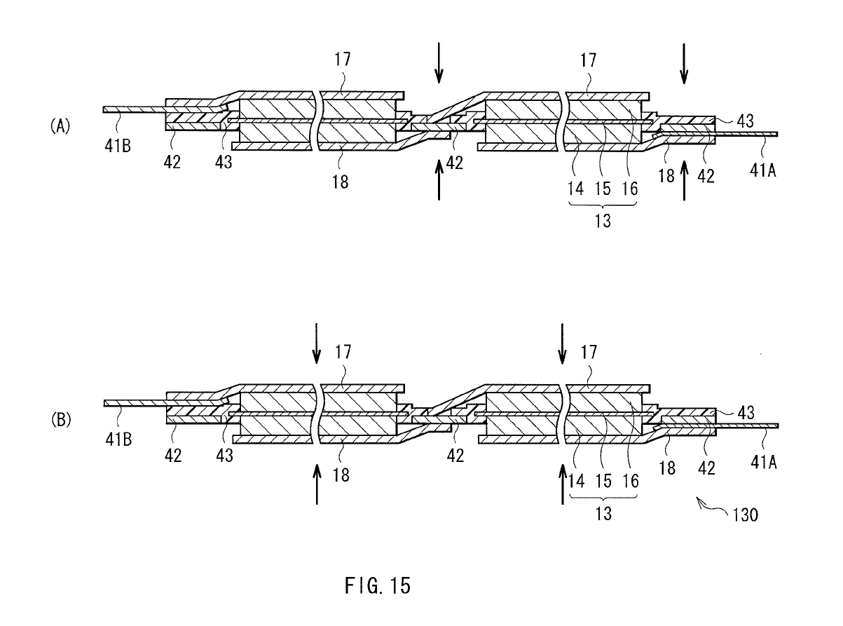

Subsequently, as illustrated in FIG. 14(B), the linked nine electrolyte membranes 15 are respectively aligned with the fuel electrode 16 and the separator 17. After that, each end of the respective separators 17 is jointed with the titanium sheet 42 by resistance welding. At this time, in the left end (− side end) in FIG. 15, the electrode terminal 41B is inserted between the seal section 43 and the separator 17.

Next, as illustrated in FIG. 15(A), the nine electrolyte membranes 15 are respectively aligned with the oxygen electrode 14 and the separator 18. After that, each end of the respective separators 18 is jointed with the titanium sheet 42 by resistance welding. At this time, in the right end (+ side end) in FIG. 15, the electrode terminal 41A is inserted between the seal section 43 and the separator 17.

Subsequently, as illustrated in FIG. 15(B), the oxygen electrode 14, the electrolyte membrane 15, and the fuel electrode 16 are heat-pressed and bonded to each other. Thereby, the assembly 130 in which the nine MEAs 13 are connected in series is formed.

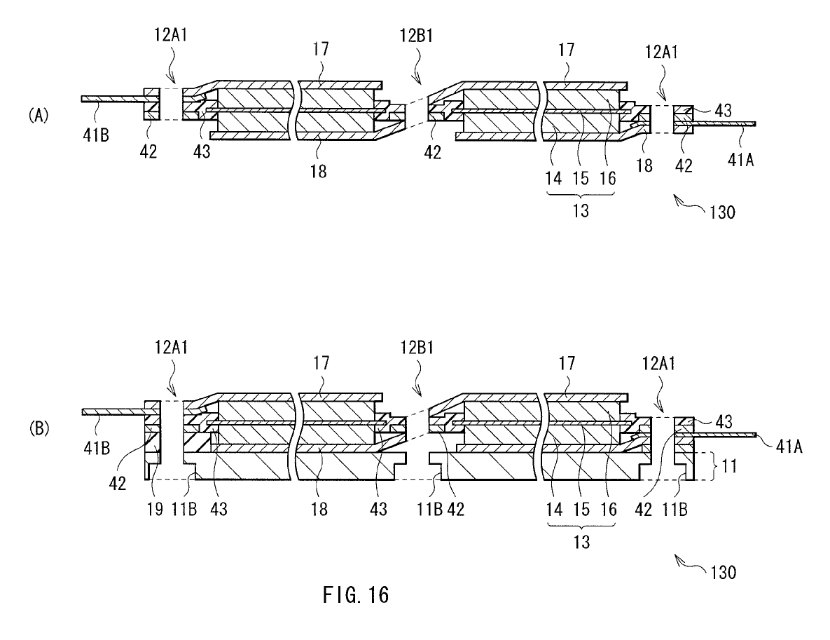

Next, as illustrated in FIG. 16(A), in the right end of the assembly 130, the aperture 12A1 is formed to penetrate the separator 18, the electrode terminal 41A, the titanium sheet 42, and the seal section 43 by, for example, sheet pressing, punching or the like. Similarly, in the left end of the assembly 130, the through hole 12A1 is formed to penetrate the titanium sheet 42, the seal section 43, the electrode terminal 41B, and the separator 17. Further in regions other than both ends of the assembly 130, the aperture 12B1 is formed to penetrate the separator 18, the titanium sheet 42, the seal section 43, and the separator 17.

Subsequently, as illustrated in FIG. 16(B), the seal section 19 is bonded to the peripheral section on the second pressing plate 11 provided with an aperture and the concave section 11B corresponding to the through holes 12A1 and 12B1. After that, the assembly 130 is laid and heat-pressed. After that, in the same manner as that of the foregoing first embodiment, the first pressing plate 10 provided with a given aperture and a concave section is laid on the separator 17 side. A resin is injected therein under given conditions. Thereby, the resin layer 40 is embedded in the through holes 12A and 12B. Accordingly, the fuel cell 2 illustrated in FIG. 11 and FIG. 12 is completed.

### 3. Operation of the Fuel Cell 2

In the fuel cell 2, as in the fuel cell 1 of the foregoing first embodiment, while a fuel is supplied to the fuel electrode 16, oxygen is supplied to the oxygen electrode 14. In the result, redox reaction is initiated, and chemical energy of the fuel is converted to electric energy, resulting in generation of electric power. In this embodiment, the thorough hole 12A is provided in both ends of the assembly 130, the thorough hole 12B is provided in the regions other than both ends of the assembly 130, and the resin layer 40 is embedded in the thorough holes 12A and 12B. By fastening with the use of the resin as above, the assembly 130 is sandwiched between the first pressing plate 10 and the second pressing plate 11, and is held under pressure.

Electric power generated in the assembly 130 obtained by such resin fastening is extracted outside through the electrode terminals 41A and 41B attached to both ends of the assembly 130. In terms of physical strength or the like, the through hole 12A is formed to penetrate the electrode sections 410 and 412, and the resin layer 40 is embedded in the through hole 12A. However, in the case where the through hole 12A is provided in the electrode sections 410 and 412 and the resin layer 40 is embedded in the through hole 12A, since the width B1 of the electrode sections 410 and 412 is narrow about from 1 mm to 3 mm both inclusive, the electrode sections 410 and 412 are broken at the time of pressurization in some cases.

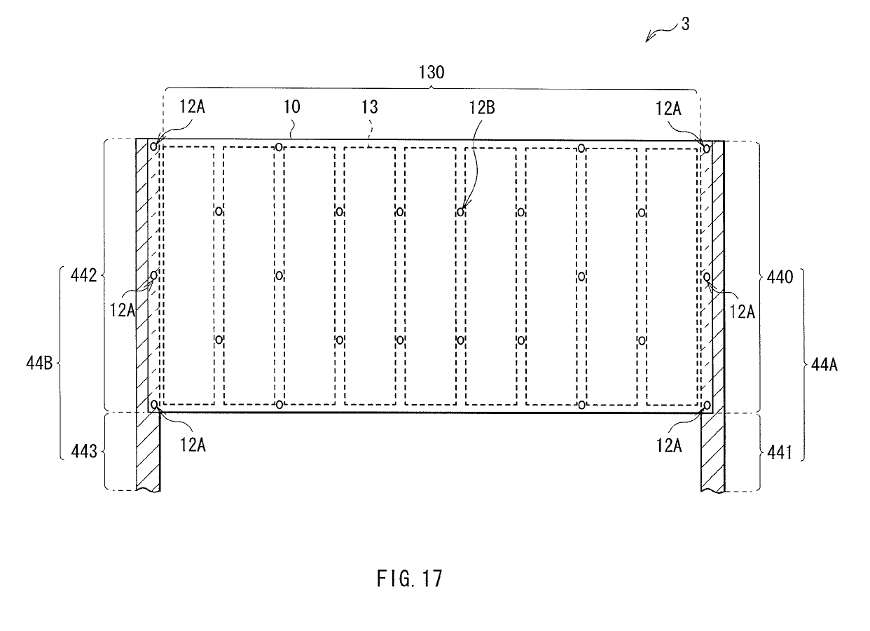

Here, FIG. 17 illustrates a planar structure of a fuel cell 3 seen from the first pressing plate 10 side as a modified example of this embodiment (second modified example). In the fuel cell 3, electrode terminals 44A and 44B for extracting electric power outside are attached to both ends of the assembly 130. In the electrode terminals 44A and 44B, electrode sections 440 and 442 are provided along an end side of the assembly 130, and terminal sections 441 and 443 are provided by extending one end of the electrode sections 440 and 442. That is, the electrode terminals 44A and 44B have a structure in which the terminal sections 441 and 443 are drawn out along the direction in parallel with the extending direction of the electrode sections 440 and 442 from one end of the electrode sections 440 and 442. As described above, the drawing-out direction of the terminal sections 441 and 443 in the electrode terminals 44A and 44B may be in parallel with the extending direction of the electrode sections 440 and 442.

However, in such a fuel cell 3, in the case where breakage of the electrode sections 440 and 442 caused by the through hole 12A as described above is generated, it is difficult to stably extract electric power from the assembly 130. Further, there is a possibility that heat is generated by conductive resistance in the electrode sections 440 and 442.

Meanwhile, in this embodiment, the terminal sections 411 and 413 are drawn out in the direction not in parallel with the extending direction of the electrode sections 410 and 412. Thereby, if breakage of the electrode sections 410 and 412 is caused by the through hole 12A, electric power is stably extracted. Further, the width B2 of the electrode sections 411 and 413 is wider than the width B1, for example, in the vicinity of the center of the electrode sections 410 and 412. Thereby, the cross sectional area of the electrode sections 411 and 413 is able to be secured without relation to the width B1 of the electrode sections 410 and 412. Thus, physical strength of the electrode sections 411 and 413 is retained, and conductive resistance in the electrode sections 411 and 413 is decreased.

As described above, in this embodiment, the thorough hole 12A is provided in both ends of the assembly 130, and the electrode terminals 41A and 41B for extracting electric power outside are provided. Thus, in performing resin fastening of the assembly 130, while physical strength is secured, electric power is able to be extracted outside. In particular, in the case where in the electrode terminals 41A and 41B, the terminal sections 411 and 413 are drawn out in the direction not in parallel with the extending direction of the electrode sections 410 and 412, not only effect equal to that of the foregoing first embodiment is able to be obtained, electric power is able to be extracted more stably. Further, heat generation due to conductive resistance is able to be inhibited.

In this embodiment, the description has been given of the electrode terminals 41A and 41B for extracting electric power outside with a specific example of the assembly 130 in which the nine MEAs are connected in series. However, such an electrode terminal structure is able to be applied to the foregoing first embodiment and the foregoing first modified example. On the contrary, in this embodiment, it is possible that each cross sectional areas of the through holes is changed according to each region in the plane of the assembly to realize more uniform pressure holding as in the foregoing first modified example.

### Third Modified Example

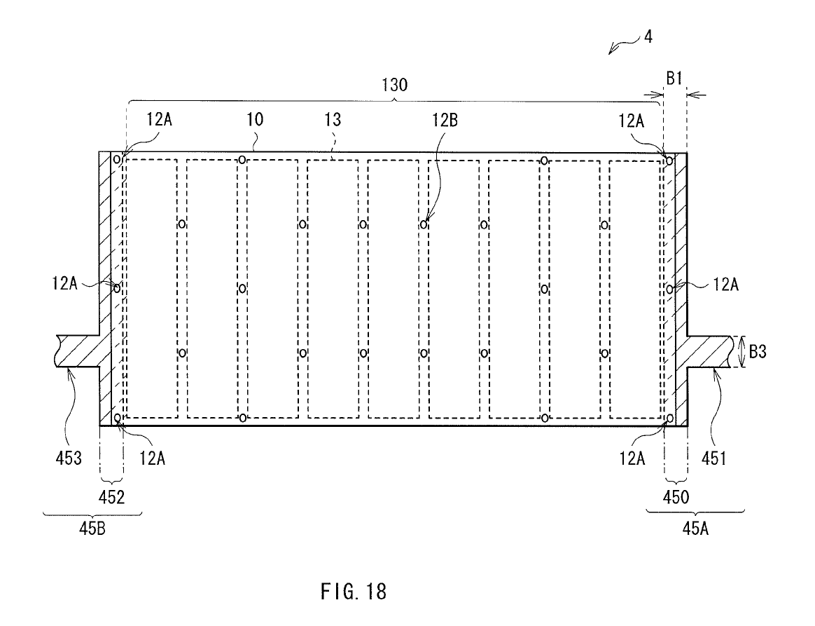

FIG. 18 is a view seen from the side of the first pressing plate 10 of a fuel cell 4 according to a modified example (third modified example) of the foregoing second embodiment. In this modified example, as in the foregoing second embodiment, in electrode terminals 45A and 45B attached to both ends of the assembly 130, electrode sections 450 and 452 are provided along an end side of the assembly 130, and the through hole 12A is formed to penetrate the electrode sections 450 and 452. Further, terminal sections 451 and 453 are drawn out in the direction not in parallel with (in the direction orthogonal to) the extending direction of the electrode sections 450 and 452.

However, in this modified example, the terminal sections 451 and 453 are drawn out from a region between adjacent through holes 12A of the electrode sections 450 and 452. The electrode sections 450 and 452 have the width B1 equal to that of the electrode sections 410 and 412 of the foregoing second embodiment, and width B3 of the terminal sections 451 and 453 is, for example, about from 3 mm to 10 mm both inclusive. The component material of the electrode terminals 45A and 45B is similar to that of the electrode terminals 41A and 41B of the foregoing second embodiment. Further, elements other than the electrode terminals 45A and 45B have a structure similar to that of the foregoing second embodiment.

As described above, in the electrode terminals 45A and 45B, the terminal sections 451 and 453 may be drawn out from the region between adjacent through holes 12A of the electrode sections 450 and 452 in the direction not in parallel with the extending direction of the electrode sections 450 and 452. Thereby, in the case where breakage of the electrode sections 450 and 452 caused by the through hole 12A as described above is generated, electric power is able to be stably extracted. Further, heat generation due to conductive resistance is able to be inhibited more compared to the fuel cell 3 illustrated in FIG. 17. Thus, effect almost equal to that of the foregoing second embodiment is able to be obtained.

### Fourth Modified Example

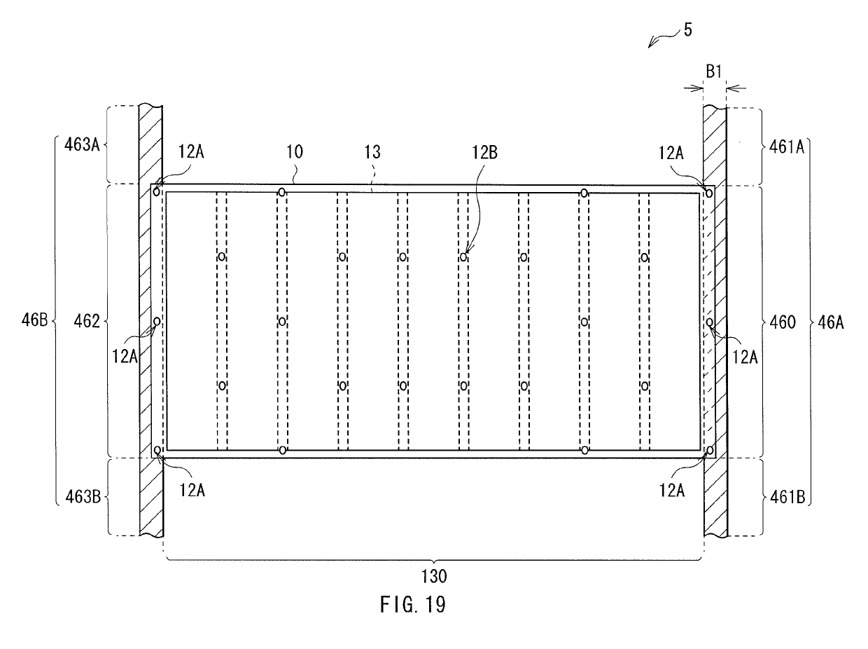

FIG. 19 is a view seen from the side of the first pressing plate 10 of a fuel cell 5 according to a modified example (fourth modified example) of the foregoing second embodiment. In this modified example, as in the foregoing second embodiment, in electrode terminals 46A and 46B attached to both ends of the assembly 130, electrode sections 460 and 462 are provided along an end side of the assembly 130, and the through hole 12A is provided to penetrate the electrode sections 460 and 462. However, in this modified example, terminal sections (terminal sections 461A, 461B, 463A, and 463B) having the same width B1 as that of the electrode sections 460 and 462 are drawn out in the direction in parallel with the extending direction of the electrode sections 460 and 462 from both ends of the electrode sections 460 and 462 having the width B1. The component material of the electrode terminals 46A and 46B is similar to that of the electrode terminals 41A and 41B of the foregoing second embodiment. Further, elements other than the electrode terminals 46A and 46B have a structure similar to that of the foregoing second embodiment.

As described above, in the electrode terminals 46A and 46B, the terminal sections 461A, 461B, 463A, and 463B may be drawn out from both ends of the electrode sections 460 and 462 in the direction in parallel with the extending direction of the electrode sections 460 and 462. Thereby, compared to the structure in which the terminal section is drawn out from only one end of the electrode section as in the fuel cell 3 illustrated in FIG. 17, electric power is able to be stably extracted, and heat generation due to conductive resistance is able to be inhibited. Thus, effect almost equal to that of the foregoing second embodiment is able to be obtained.

The present invention has been described with reference to the embodiments and the modified examples. However, the present invention is not limited to the foregoing embodiments and the like, and various modifications may be made. For example, in the foregoing embodiments, the specific description has been given of the structures of the electrolyte membrane 15, the fuel electrode 16, and the oxygen electrode 14. However, the electrolyte membrane 15, the fuel electrode 16, and the oxygen electrode 14 may have other structure, or may be made of other material.

Further, in the foregoing embodiments and the like, the specific description has been given of the case that the plurality of MEAs are layered horizontally in the in-plane direction. However, the structure is not limited thereto, but the present invention is applicable to a structure in which the plurality of MEAs are layered in the vertical direction. Further, in the foregoing embodiments and the like, the specific description has been given of the structure in which the six MEAs are connected in the shape of U and the structure in which the nine MEAs are linearly connected. However, the number of MEAs and the connection direction thereof are not limited thereto, but it is enough that the plurality of MEAs are electrically connected in series.

Further, in the foregoing embodiments and the like, the seal section is arranged on the second pressing plate side to seal the region on the oxygen electrode side of the respective MEAs. However, the seal section may be arranged on the first pressing plate side to seal the region on the fuel electrode side. Further, the specific description has been given of the case that the seal section is provided around the respective MEAs. However, the seal section may be provided only in the outer circumferential section of the fuel cell.

In addition, the present invention is applicable not only to the DMFC, but also to other type of fuel cell such as a Polymer Electrolyte Fuel Cell using hydrogen as a fuel, a Direct Ethanol Fuel Cell, and a Dimethyl Ether Fuel Cell.

1. A fuel cell comprising:
a Membrane Electrolyte Assembly (MEA) in which a fuel electrode and an oxygen electrode are oppositely arranged with an electrolyte membrane in between;
a pair of pressing plates that respectively provided on the fuel electrode side and the oxygen electrode side of the MEA, and arranged oppositely to the MEA and a peripheral region thereof;
a through hole penetrating from one of the pair of pressing plates to the other of the pair of pressing plates through the peripheral region of the MEA; and
a resin layer embedded in the through hole.

2. The fuel cell according to claim 1, wherein a plurality of the MEAs are arranged in the in-plane direction.

3. The fuel cell according to claim 2, wherein the through hole is provided respectively in each peripheral region of the respective MEAs.

4. The fuel cell according to claim 3, wherein a cross sectional area of the through hole in an internal region of the pair of pressing plates is larger than that in an end region of the pair of pressing plates.

5. The fuel cell according to claim 4, wherein a planar shape of the pair of pressing plates is a rectangle, and
the cross sectional area of the through hole is the smallest in four corners of the rectangle.

6. The fuel cell according to claim 3, wherein the through hole in an internal region of the pair of pressing plates is provided more densely than that in an end region of the pair of pressing plates.

7. The fuel cell according to claim 2 comprising:
a connection member that links the respective MEAs with each other, and that has an aperture in a region corresponding to the through hole.

8. The fuel cell according to claim 7, wherein an assembly is composed by electrically connecting the plurality of MEAs in series, comprising:
an electrode terminal that is linked to an end in a connection direction of the assembly and that extracts electric power outside.

9. The fuel cell according to claim 8, wherein the through hole also penetrates the electrode terminal in the end of the assembly.

10. The fuel cell according to claim 9, wherein the electrode terminal has
an electrode section extending along an end side of the assembly, and
a terminal section drawn out from part of the electrode section to outside.

11. The fuel cell according to claim 10, wherein the terminal section is drawn out in a direction not in parallel with an extending direction of the electrode section.

12. The fuel cell according to claim 11, wherein a width of the terminal section drawn out is larger than a width of the electrode section in the plane of the assembly.

13. The fuel cell according to claim 11, wherein a plurality of through holes are provided in a region corresponding to the electrode section, and
the terminal section is drawn out from between adjacent through holes out of the plurality of through holes in the region corresponding to the electrode section.

14. The fuel cell according to claim 7 comprising:
an adhesive layer having an aperture in a region corresponding to the through hole between one pressing plate and the connection member in the peripheral region of the MEA.

15. The fuel cell according to claim 1, wherein a concave section having a bottom face with a larger area than that of the through hole is provided on a surface side of a region corresponding to the through hole of the pair of pressing plates.

16. The fuel cell according to claim 1, wherein the pair of pressing plates respectively have an aperture forming part of the through hole, and
a shape of each aperture is equal to each other.

17. A method of manufacturing a fuel cell comprising the steps of:
forming a Membrane Electrolyte Assembly (MEA) in which a fuel electrode and an oxygen electrode are oppositely arranged with an electrolyte membrane in between; and
sandwiching the MEA and a peripheral region thereof between a pair of pressing plates that have each aperture opposite to each other in the peripheral region, and injecting a molten thermoplastic resin material under a given pressure into the aperture of one of the pair of pressing plates.

18. The method of manufacturing a fuel cell according to claim 17, wherein the resin material is injected into the aperture of the pressure plate on the fuel electrode side of the pair of pressing plates.

19. The method of manufacturing a fuel cell according to claim 17, wherein a plurality of apertures are formed in each of the pair of pressing plates, and
the resin material is concurrently injected into the plurality of apertures of one of the pair of pressing plates.

20. The method of manufacturing a fuel cell according to claim 17, wherein a concave section having a bottom face with a larger area than that of a through hole is formed on a surface side of a region corresponding to the through hole of the pair of pressing plates.
